(19) United States
(12) Patent Application Publication
(10) Pub. No.: US 2010/0101859 A1
(43) Pub. Date: Apr. 29, 2010

(54) CONDUCTIVE CONNECTOR FOR ELECTRONIC COMPONENTS

(75) Inventor: CHIN-WEN HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/503,862

(22) Filed: Jul. 16, 2009

(30) Foreign Application Priority Data
Oct. 28, 2008 (CN) 200810305254.9

(51) Int. Cl. H01R 4/62

(52) U.S. Cl. 174/94 R

(57) ABSTRACT

A conductive connector for electrically connecting electronic components comprises a first conductive body and a second conductive body. At least one protrusion is defined in the second conductive body. The first conductive body and the second conductive body are joined together. The at least one protrusion abuts the first conductive body.

### BACKGROUND

1. Technical Field

The present disclosure relates to connecting technology, and particularly, to a conductive connector for electronic components.

2. Description of Related Art

Generally, a conductive connector for electronic components includes two metallic plates. The electronic components are electrically positioned on each metallic plate. The two metallic plates are joined to electrically connect electronic components using a heat staking process at a plurality of heat staking points. However, contacting area between the two metallic plates is so small that contacting impedance between the two metallic plates is too high. As a result, the electrical conductivity between the two metallic plates is unsatisfactory.

Therefore, what is needed is to provide a conductive connector for electronic components, in which the limitations described above, are eliminated or at least alleviated.

### BRIEF DESCRIPTION OF THE DRAWINGS

FIG. 1 is a schematic isometric view of a conductive connector, according to a first exemplary embodiment.

FIG. 2 is a cross-sectional view taken along line II-II of the conductive connector of FIG. 1.

FIG. 3 is a schematic isometric view of a conductive connector, according to a second exemplary embodiment.

### DETAILED DESCRIPTION

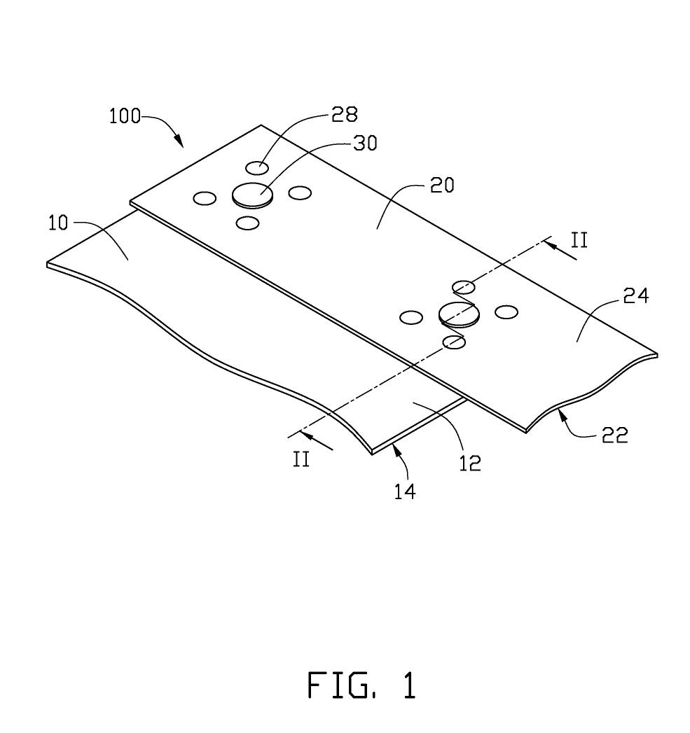

Referring to FIG. 1, a conductive connector 100 for electrically connecting electronic components (not shown), such as circuit boards, according to a first exemplary embodiment, is shown. The conductive connector 100 includes a first conductive body 10 and a second conductive body 20. The first conductive body 10 and the second conductive body 20 are joined to each other by joints using a heat staking process. The first conductive body 10 and the second conductive body 20 may be metal sheets made from copper or gold.

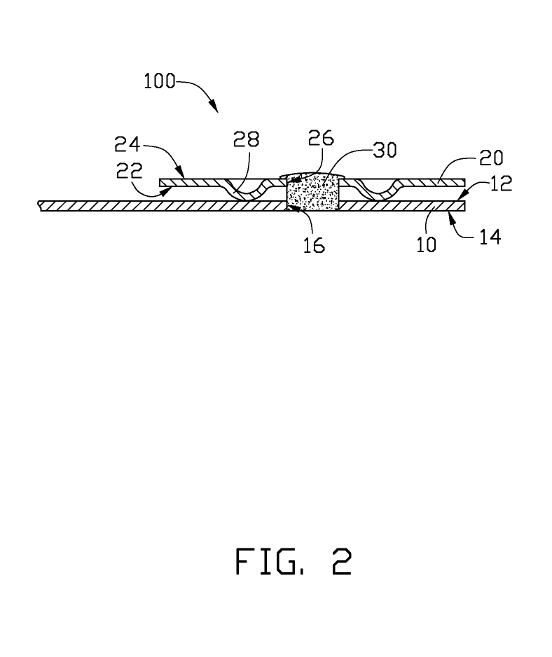

Further referring to FIG. 2, the first conductive body 10 includes a first surface 12 and a second surface 14. The first surface 12 and the second surface 14 are on opposite sides of the first conductive body 10. Two first through holes 16 are defined in the first conductive body 10.

The second conductive body 20 includes a third surface 22 and a fourth surface 24. The third surface 22 faces the first surface 12. The third surface 22 and the fourth surface 24 are on opposite sides of the second conductive body 20. Two second through holes 26 are defined in the second conductive body 20 corresponding to the first through holes 16. The second conductive body 20 is punched from the fourth surface 24 to form four protrusions 28 symmetrical to each other around the second through holes 26.

When the first conductive body 10 and the second conductive body 20 are joined to each other by joints using the heat staking process, the first through hole 16 is aligned with the second through hole 26. The first through hole 16 and the second through hole 26 become filled with fusing material 30, and the protrusions 28 firmly abut the first surface 12. As a result, contacting area between the first conductive body 10 and the second conductive body 20 is large, and contacting impedance between the first conductive body 10 and the second conductive body 20 is small. Therefore, the electrical conductivity of the conductive connector 100 is satisfactory.

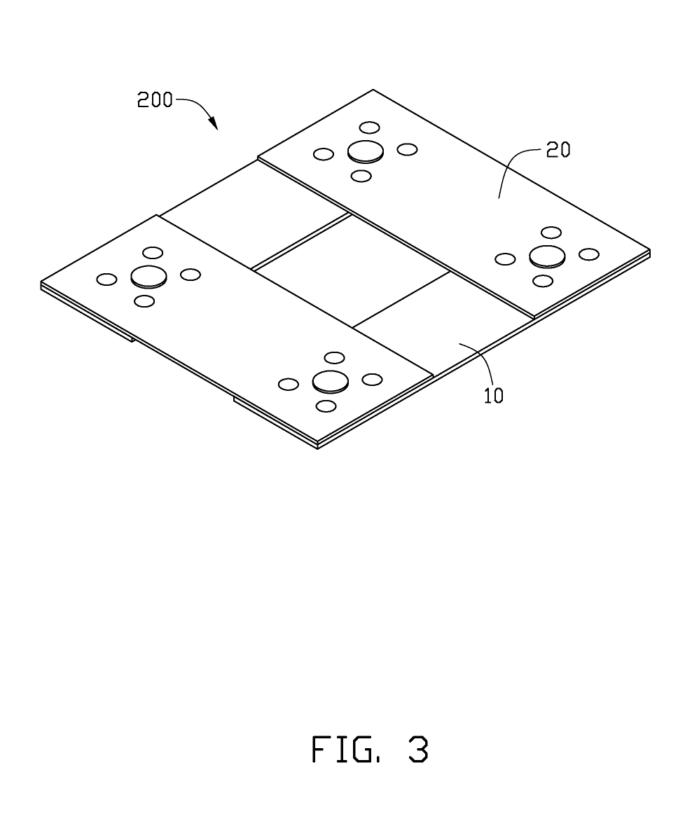

Referring to FIG. 3, a conductive connector 200 for electrically connecting electronic components (not shown), according to a second exemplary embodiment, includes two parallel first conductive bodies 10 and two parallel second conductive bodies 20. The first conductive bodies 10 and the second conductive bodies 20 are joined end to end by a heat staking process.

Advantages of the second exemplary embodiment are similar to those of the first exemplary embodiment.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A conductive connector for electrically connecting electronic components, comprising:
a first conductive body; and
a second conductive body defining at least one protrusion;
wherein the first conductive body and the second conductive body are joined to each other, and the at least one protrusion abuts the first conductive body.

2. The conductive connector as claimed in claim 1, wherein the first conductive body and the second conductive body are joined by joints using a heat staking process.

3. The conductive connector as claimed in claim 1, wherein the first conductive body and the second conductive body are made from copper.

4. The conductive connector as claimed in claim 1, wherein the first conductive body and the second conductive body are made from gold.

5. The conductive connector as claimed in claim 1, wherein the at least one protrusion is formed by punching.

6. The conductive connector as claimed in claim 1, wherein the first conductive body comprises a first surface and a second surface opposite to the first surface; and the second conductive body comprises a third surface facing the first surface and a fourth surface opposite to the third surface; and wherein the at least one protrusion is formed on the third surface and abuts the first surface.

7. The conductive connector as claimed in claim 1, wherein at least one first through hole is defined in the first conductive body; at least one second through hole is defined in the second conductive body corresponding to the at least one first through hole; and each first through hole is aligned with the corresponding second through hole.

8. The conductive connector as claimed in claim 7, wherein the at least one protrusion is formed around the second through hole.

9. The conductive connector as claimed in claim 7, wherein each first through hole and the corresponding second through hole are filled with fusing material.

10. The conductive connector as claimed in claim 1, wherein the first conductive body and the second conductive body are metal sheets.
